(19) United States
(12) Patent Application Publication
(10) Pub. No.: US 2025/0072514 A1
(43) Pub. Date: Mar. 6, 2025

(54) METHOD AND DEVICE FOR GENERATING AEROSOL

(71) Applicant: KT & G CORPORATION, Daejeon (KR)

(72) Inventors: Wonkyeong LEE, Guri-si (KR); Min Kyu KIM, Seoul (KR); Paul Joon SUNWOO, Seoul (KR)

(73) Assignee: KT & G CORPORATION, Daejeon (KR)

(21) Appl. No.: 18/276,970

(22) PCT Filed: Apr. 10, 2023
(86) PCT No.: PCT/KR2023/004773

§ 371 Date: Aug. 11, 2023

(30) Foreign Application Priority Data
Apr. 20, 2022 (KR) 10-2022-0049077

(51) Int. Cl. A24F 40/51; A24F 40/20; A24F 40/57; A24F 40/65

(52) U.S. Cl. CPC A24F 40/51; A24F 40/20; A24F 40/57; A24F 40/65

(57) ABSTRACT

A method of providing an aerosol to a user includes receiving biometric information of the user of an electronic device, determining a current state of the user based on the biometric information, when the current state corresponds to a preset target state, generating a target temperature profile by adjusting a default temperature profile based on the current state, and generating an aerosol by heating an aerosol generating substrate in the electronic device based on the target temperature profile.

### TECHNICAL FIELD

The following embodiments relate to a technique for providing an aerosol to a user of an electronic device.

### BACKGROUND ART

The demand for electronic cigarette devices has recently been on the rise. The rising demand for electronic cigarette devices has accelerated the continued development of electronic cigarette device-related functions. The electronic cigarette device-related functions may include, in particular, functions according to the types and characteristics of electronic cigarette devices.

### DISCLOSURE OF THE INVENTION

### Technical Goals

An embodiment may provide a method of providing an aerosol to a user of an electronic device.

An embodiment may provide a method of generating a temperature profile for heating an aerosol generating substrate.

### Technical Solutions

According to an embodiment, a method of generating aerosol performed by an electronic device may include receiving biometric information of a user of the electronic device, determining a current state of the user based on the biometric information, when the current state corresponds to a preset target state, generating a target temperature profile by adjusting a default temperature profile based on the current state, and generating an aerosol by heating an aerosol generating substrate in the electronic device based on the target temperature profile.

The receiving of the biometric information of the user may include generating the biometric information using at least one sensor of the electronic device.

The receiving of the biometric information of the user may include receiving, from an additional device connected to the electronic device, the biometric information generated based on one or more sensors in the additional device.

The method may further include propagating a beacon to the additional device using short-range wireless communication and connecting to the additional device based on the beacon.

The biometric information may be at least one of a heart rate, a skin temperature, a skin dryness level, and a perspiration level of the user.

The perspiration level may indicate a degree of sweat generated from a fingertip of the user.

The generating of the target temperature profile by adjusting a default temperature profile based on the current state may include generating the target temperature profile such that a second amount of aerosol generated by the target temperature profile is reduced compared to a first amount of aerosol generated by the default temperature profile.

The method may further include receiving second biometric information of the user, determining a second current state of the user based on the second biometric information, when the second current state corresponds to the target state, generating a second target temperature profile by adjusting the target temperature profile based on the second current state, and generating an aerosol by heating an aerosol generating substrate in the electronic device based on the second target temperature profile.

The electronic device may be an electronic cigarette device.

According to an embodiment, an electronic device may include a memory configured to store a program for generating an aerosol and a processor configured to perform the program, wherein the processor may be configured to receive biometric information of a user of the electronic device, determine a current state of the user based on the biometric information, when the current state corresponds to a preset target state, generate a target temperature profile by adjusting a default temperature profile based on the current state, and generate an aerosol by heating an aerosol generating substrate in the electronic device based on the target temperature profile.

According to an embodiment, a method of generating an aerosol performed by a user terminal may include receiving, from an electronic device or an additional device connected to the user terminal, biometric information of a user of the user terminal, determining a current state of the user based on the biometric information, when the current state corresponds to a preset target state, generating a target temperature profile by adjusting a default temperature profile based on the current state, and transmitting the target temperature profile to the electronic device, wherein an aerosol may be provided to the user by the electronic device using the target temperature profile.

The biometric information may be at least one of a heart rate, a skin temperature, a skin dryness level, and a perspiration level of the user.

The generating of the target temperature profile by adjusting a default temperature profile based on the current state may include generating the target temperature profile such that a second amount of aerosol generated by the target temperature profile is reduced compared to a first amount of aerosol generated by the default temperature profile.

### Effects

It is possible to provide a method of providing an aerosol to a user of an electronic device.

It is possible to provide a method of generating a temperature profile for heating an aerosol generating substrate.

### BRIEF DESCRIPTION OF DRAWINGS

FIG. 1 illustrates a system according to an embodiment.

FIGS. 2 to 4 are diagrams illustrating examples of a cigarette inserted into an electronic device according to an example.

FIGS. 5 and 6 are diagrams illustrating examples of a cigarette according to an example.

FIG. 7 is a simplified view of an electronic device according to another example.

FIG. 8 is a block diagram of an electronic device according to yet another example.

FIG. 9 is a diagram illustrating a configuration of a user terminal according to an embodiment.

FIG. 10 is a flowchart of a method of generating an aerosol performed by an electronic device according to an embodiment.

FIG. 11 is a flowchart of a method of establishing a connection between an electronic device and an additional device according to an example.

FIG. 12 is a flowchart of a method of providing an aerosol to a user based on a temperature profile generated by a user terminal according to an embodiment.

### BEST MODE FOR CARRYING OUT THE INVENTION

The following structural or functional descriptions of embodiments are merely intended for the purpose of describing the examples and the examples may be implemented in various forms. Accordingly, the embodiments are not to be construed as limited to the disclosure and should be understood to include all changes, equivalents, or replacements within the idea and the technical scope of the disclosure.

Although terms of “first” or “second” are used to explain various components, the components are not limited to the terms. These terms should be used only to distinguish one component from another component. For example, a “first” component may be referred to as a “second” component, and similarly the “second” component may be referred to as the “first” component.

It should be understood that if it is described that one component is “connected,” “coupled,” or “joined” to another component, a third component may be “connected,” “coupled,” and “joined” between the first and second components, although the first component may be directly connected, coupled, or joined to the second component.

The singular forms “a,” “an,” and “the” include the plural forms as well, unless the context clearly indicates otherwise. It will be further understood that the terms “comprises/comprising” or “includes/including” when used herein, specify the presence of stated features, integers, steps, operations, elements, components or combinations thereof, but do not preclude the presence or addition of one or more other features, integers, steps, operations, elements, components or combinations thereof.

Unless otherwise defined, all terms used herein including technical or scientific terms have the same meaning as those generally understood by one of ordinary skill in the art to which this disclosure pertains. Terms, such as those defined in commonly used dictionaries, are to be construed to have meanings matching with contextual meanings in the relevant art, and are not to be construed to have an ideal or excessively formal meaning unless otherwise defined herein.

Hereinafter, embodiments will be described in detail with reference to the accompanying drawings. In the descriptions of the embodiments referring to the accompanying drawings, like reference numerals refer to like elements and any repeated description related thereto will be omitted.

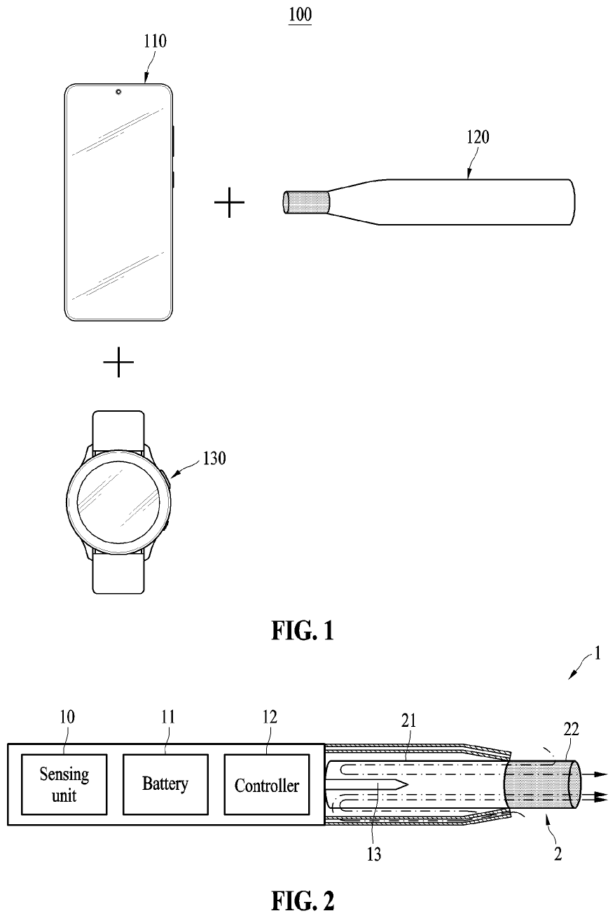

FIG. 1 illustrates a system according to an embodiment.

According to an embodiment, a system 100 may include at least one of a user terminal 110, an electronic device 120, and a wearable device 130. For example, the system 100 may include the user terminal 110, the electronic device 120, and the wearable device 130. As another example, the system 100 may include the electronic device 120 and the wearable device 130. As yet another example, the system 100 may include the electronic device 120.

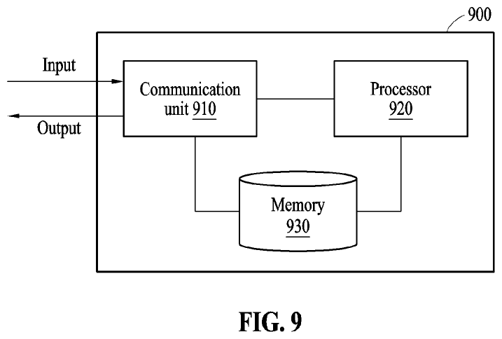

According to an aspect, the user terminal 110 may be a mobile communication device such as a smartphone. A configuration of the user terminal 110 will be described in detail with reference to FIG. 9.

According to an aspect, the electronic device 120 may be referred to as an electronic cigarette device or a smoking stick. The electronic device 120 will be described in detail below with reference to FIGS. 2 to 8.

According to an aspect, the wearable device 130 may be an electronic device that may be worn on a part of a body of a user. The wearable device 130 may be, for example, a smartwatch, but is not limited thereto.

The user may smoke as being provided with an aerosol generated by the electronic device 120. The electronic device 120 may be referred to as an aerosol generating device. For example, the electronic device 120 may generate an aerosol by heating a cigarette inserted into the electronic device 120. As another example, the electronic device 120 may generate an aerosol using a material in a liquid-type cartridge or a solid-type cartridge in the electronic device 120. The method by which the electronic device 120 generates an aerosol is not limited to the embodiments described above.

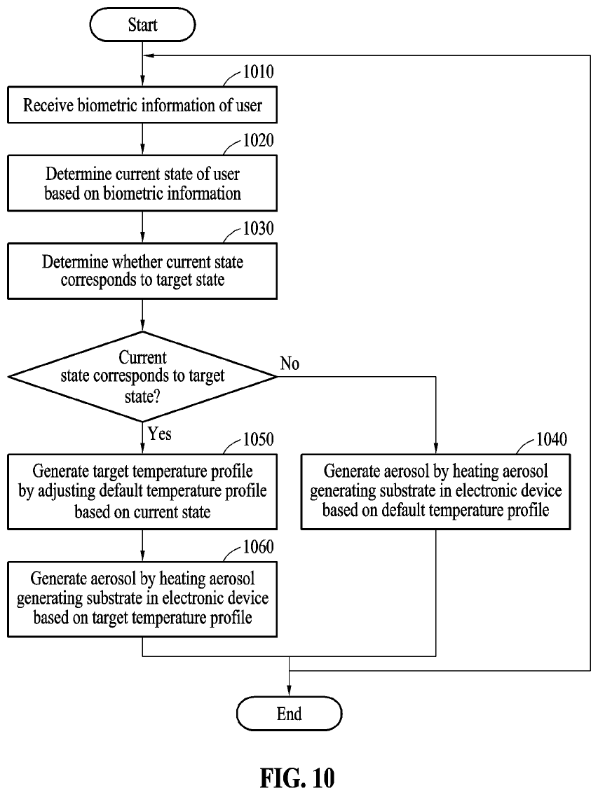

According to an embodiment, the electronic device 120 may generate sensing information related to a state of the electronic device 120 using various sensors included in the electronic device 120, and transmit the sensing information to the user terminal 110. For example, the sensing information may include biometric information, inhalation information, and exhalation information of the user who uses the electronic device 120. The user terminal 110 may generate health data related to a heart rate, lung capacity, or intake of air of the user through the biometric information, the inhalation information, and the exhalation information and provide a service related to health care or provision of an aerosol to the user based on the health data. A method of providing an aerosol to a user through the electronic device 120 will be described in detail below with reference to FIGS. 10 to 12.

According to an embodiment, the wearable device 130 may generate biometric information and exercise information of the user using various sensors included in the wearable device 130. The sensed information may be transmitted to the user terminal 110 or the electronic device 120. For example, the user terminal 110 may control the electronic device 120 based on at least one of the biometric information or exercise information of the user obtained through the electronic device 120 and/or the wearable device 130.

FIGS. 2 to 4 are diagrams illustrating examples of a cigarette inserted into an electronic device according to an example.

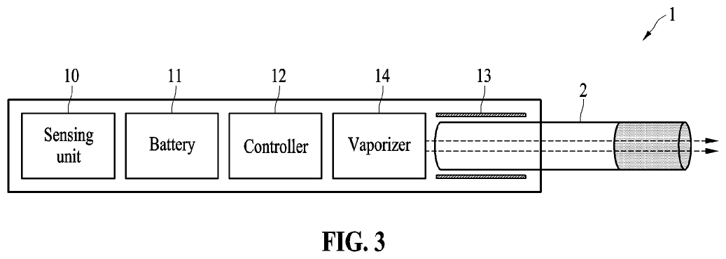

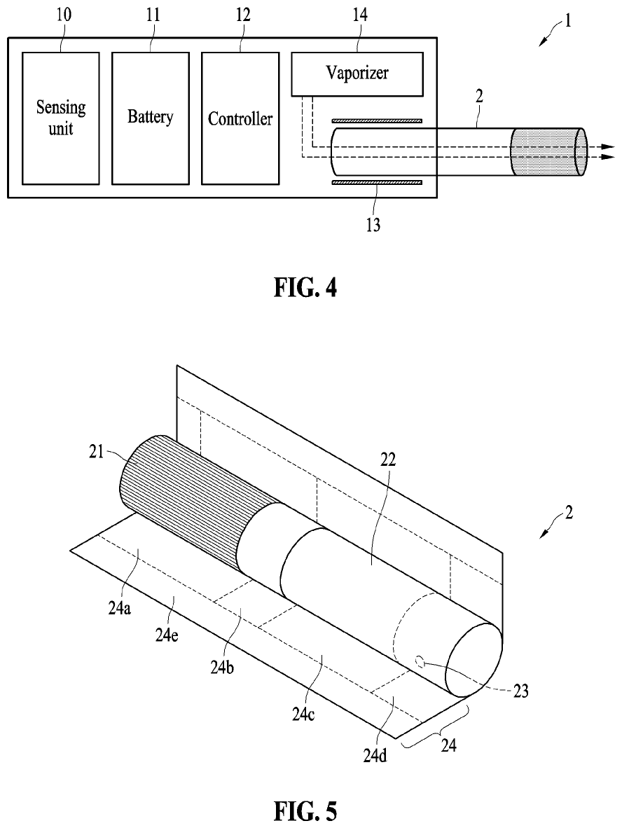

Referring to FIG. 2, an electronic device 1 may include a sensing unit 10, a battery 11, a controller 12, and a heater 13. Referring to FIGS. 3 and 4, the electronic device 1 may further include a vaporizer 14. A cigarette 2 may be inserted into an inner space of the electronic device 1. The electronic device 1 may be the electronic device 120 described above with reference to FIG. 1.

According to an embodiment, the electronic device 1 may further include a display.

The electronic device 1 illustrated in FIGS. 2 to 4 may include components related to the embodiments described herein. Therefore, it is to be understood by one of ordinary skill in the art to which the disclosure pertains that the electronic device 1 may further include other general-purpose components in addition to the ones illustrated in FIGS. 2 to 4.

In addition, although it is illustrated that the heater 13 is included in the electronic device 1 in FIGS. 3 and 4, the heater 13 may be omitted as needed.

FIG. 2 illustrates a linear alignment of the sensing unit 10, the battery 11, the controller 12, and the heater 13. In addition, FIG. 3 illustrates a linear alignment of the sensing unit 10, the battery 11, the controller 12, the vaporizer 14, and the heater 13. Further, FIG. 4 illustrates a parallel alignment of the vaporizer 14 and the heater 13. However, an internal structure of the electronic device 1 is not limited to what is shown in FIGS. 2 to 4. That is, such alignments of the sensing unit 10, the battery 11, the controller 12, the heater 13, and the vaporizer 14 may be changed depending on the design of the electronic device 1.

When the cigarette 2 is inserted into the electronic device 1, the electronic device 1 may operate the heater 13 and/or the vaporizer 14 to generate an aerosol. The aerosol generated by the heater 13 and/or the vaporizer 14 may pass through the cigarette 2 into the user.

Even when the cigarette 2 is not inserted into the electronic device 1, the electronic device 1 may heat the heater 13 as needed.

The battery 11 may supply power to be used to operate the electronic device 1. For example, the battery 11 may supply power to heat the heater 13 or the vaporizer 14, and may supply power required for the controller 12 to operate. In addition, the battery 11 may supply power required to operate a display, a sensor, a motor, or the like installed in the electronic device 1.

The controller 12 controls the overall operation of the electronic device 1. Specifically, the controller 12 may control respective operations of other components included in the electronic device 1, in addition to the sensing unit 10, the battery 11, the heater 13, and the vaporizer 14. In addition, the controller 12 may verify a state of each of the components of the electronic device 1 to determine whether the electronic device 1 is in an operable state.

The controller 12 may include at least one processor. The processor may be implemented as an array of a plurality of logic gates, or may be implemented as a combination of a general-purpose microprocessor and a memory in which a program executable in the microprocessor is stored. In addition, it is to be understood by one of ordinary skill in the art to which the present disclosure pertains that the processor may be implemented in other types of hardware.

The heater 13 may be heated by power supplied by the battery 11. For example, when the cigarette is inserted into the electronic device 1, the heater 13 may be disposed outside the cigarette. The heated heater 13 may thus raise a temperature of an aerosol generating material (or substrate) in the cigarette.

The heater 13 may be an electrically resistive heater. For example, the heater 13 may include an electrically conductive track, and the heater 13 may be heated as a current flows through the electrically conductive track. However, the heater 13 is not limited to the foregoing example, and any example of heating the heater 13 up to a desired temperature may be applicable without limitation. Here, the desired temperature may be preset in the electronic device 1 or may be set by the user. For example, a temperature of the heater 13 may be controlled based on a temperature profile. According to an aspect, the temperature profile may be a profile of a target temperature change during an operating time. According to another aspect, the temperature profile may be a profile of a current change provided during the operating time. The temperature of the heater 13 may change according to the current change.

As another example, the heater 13 may be an induction heater. Specifically, the heater 13 may include an electrically conductive coil for heating the cigarette in an inductive heating manner, and the cigarette may include a susceptor to be heated by the induction heater.

For example, the heater 13 may include a tubular heating element, a plate-shaped heating element, a needle-shaped heating element, or a rod-shaped heating element, and may heat the inside or outside of the cigarette 2 according to the shape of a heating element.

In addition, the heater 13 may be provided as a plurality of heaters in the electronic device 1. In this case, the plurality of heaters 13 may be disposed to be inserted into the cigarette 2, or may be disposed outside the cigarette 2. In addition, some of the heaters 13 may be disposed to be inserted into the cigarette 2, and the rest may be disposed outside the cigarette 2. However, the shape of the heater 13 is not limited to what is shown in FIGS. 2 to 4 but may be provided in various shapes.

The vaporizer 14 may heat a liquid composition to generate an aerosol, and the generated aerosol may pass through the cigarette 2 into the user. That is, the aerosol generated by the vaporizer 14 may travel along an airflow path of the electronic device 1, and the airflow path may be configured such that the aerosol generated by the vaporizer 14 may pass through the cigarette into the user. For example, a temperature of the vaporizer 14 may be controlled based on the temperature profile. According to an aspect, the temperature profile may be the profile of the target temperature change during an operating time. According to another aspect, the temperature profile may be the profile of the current change provided during the operating time. The temperature of the vaporizer 14 may change according to the current change.

For example, the vaporizer 14 may include a liquid storage, a liquid transfer means, and a heating element, but is not limited thereto. For example, the liquid storage, the liquid transfer means, and the heating element may be included as independent modules in the electronic device 1.

The liquid storage may store the liquid composition. The liquid composition may be, for example, a liquid including a tobacco-containing material that includes a volatile tobacco flavor component, or may be a liquid including a non-tobacco material. The liquid storage may be manufactured to be detachable and attachable from and to the vaporizer 14, or may be manufactured in an integral form with the vaporizer 14.

The liquid composition may include, for example, water, a solvent, ethanol, a plant extract, a fragrance, a flavoring agent, or a vitamin mixture. The fragrance may include, for example, menthol, peppermint, spearmint oil, various fruit-flavored ingredients, and the like, but is not limited thereto. The flavoring agent may include ingredients that provide the user with a variety of flavors or scents. The vitamin mixture may be a mixture of at least one of vitamin A, vitamin B, vitamin C, or vitamin E, but is not limited thereto. The liquid composition may also include an aerosol former such as glycerin and propylene glycol.

The liquid transfer means may transfer the liquid composition in the liquid storage to the heating element. The liquid transfer means may be, for example, a wick such as cotton fiber, ceramic fiber, glass fiber, or porous ceramic, but is not limited thereto.

The heating element may be an element for heating the liquid composition transferred by the liquid transfer means. The heating element may be, for example, a metal heating wire, a metal heating plate, a ceramic heater, or the like, but is not limited thereto. In addition, the heating element may include a conductive filament such as a nichrome wire, and may be arranged in a structure wound around the liquid transfer means. The heating element may be heated as a current is supplied and may transfer heat to the liquid composition in contact with the heating element, and may thereby heat the liquid composition. As a result, an aerosol may be generated.

For example, the vaporizer 14 may also be referred to as a cartomizer or an atomizer, but is not limited thereto.

The electronic device 1 may further include general-purpose components in addition to the sensing unit 10, the battery 11, the controller 12, the heater 13, and the vaporizer 14. For example, the electronic device 1 may include a display that outputs visual information and/or a motor that outputs tactile information.

According to an embodiment, the sensing unit 10 may include one or more biosensors. For example, the biosensors may include one or more of a heart rate sensor, a blood pressure sensor, an electrocardiogram sensor, or a blood oxygen saturation sensor. The biosensors may include sensors configured to measure biosignals of the user, and are not limited to the embodiments described above. When the user grabs the electronic device 1, a biosignal of the user may be measured.

According to an embodiment, the sensing unit 10 may include a sensor configured to measure a body composition of the user. For example, the body composition may include a skeletal muscle mass, a basal metabolic rate, a body water content, and a body fat mass. When the user grabs the electronic device 1, the body composition of the user may be measured.

According to an embodiment, the sensing unit 10 may further include a puff sensor, a temperature sensor, and a cigarette insertion detection sensor. In addition, the electronic device 1 may be manufactured to have a structure that allows external air to be introduced or internal gas to be discharged even in a state in which the cigarette 2 is inserted.

Although not shown in FIGS. 2 to 4, the electronic device 1 may constitute a system along with a separate cradle. For example, the cradle may be used to charge the battery 11 of the electronic device 1. Alternatively, the cradle may be used to heat the heater 13, with the cradle and the electronic device 1 coupled.

The cigarette 2 may be similar to a general combustible cigarette. For example, the cigarette 2 may be divided into a first portion including an aerosol generating material and a second portion including a filter or the like. Alternatively, the second portion of the cigarette 2 may also include the aerosol generating material. For example, the aerosol generating material provided in the form of granules or capsules may be inserted into the second portion.

The first portion may be entirely inserted into the electronic device 1, and the second portion may be exposed outside. Alternatively, the first portion may be only partially inserted into the electronic device 1, and the first portion may be entirely inserted and the second portion may be partially inserted into the electronic device 1. The user may then inhale an aerosol with the second portion in a mouth of the user. In this case, an aerosol may be generated as external air passes through the first portion, and the generated aerosol may pass through the second portion to be into the mouth of the user.

For example, the external air may be introduced through at least one air passage formed in the electronic device 1. For example, opening or closing and/or a size of an air path formed in the electronic device 1 may be adjusted by the user. Accordingly, an amount of atomization, a sense of smoking, or the like may be adjusted by the user. As another example, the external air may be introduced into the inside of the cigarette 2 through at least one hole formed on a surface of the cigarette 2.

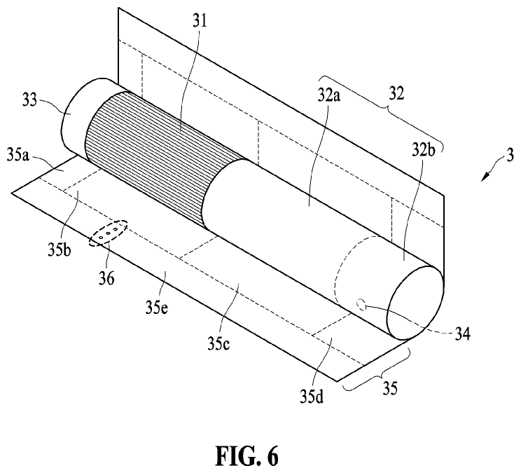

Hereinafter, examples of the cigarette 2 will be described with reference to FIGS. 5 and 6,

FIGS. 5 and 6 are diagrams illustrating examples of a cigarette according to an example.

Referring to FIG. 5, the cigarette 2 may include a tobacco rod 21 and a filter rod 22. The first portion and the second portion described above with reference to FIGS. 2 to 4 may include the tobacco rod 21 and the filter rod 22, respectively.

Although the filter rod 22 is illustrated as having a single segment in FIG. 5, embodiments are not limited thereto. That is, the filter rod 22 may include a plurality of segments. For example, the filter rod 22 may include a segment that cools an aerosol and a segment that filters out certain components contained in an aerosol. In addition, the filter rod 22 may further include at least one segment that performs another function as needed.

A diameter of the cigarette 2 may be in a range of 5 millimeters (mm) to 9 mm, and a length thereof may be about 48 mm. However, embodiments are not limited thereto. For example, a length of the tobacco rod 21 may be about 12 mm, a length of a first segment of the filter rod 22 may be about 10 mm, a length of a second segment of the filter rod 22 may be about 14 mm, and a length of a third segment of the filter rod 22 may be about 12 mm. However, embodiments are not limited thereto.

The cigarette 2 may be wrapped with at least one wrapper 24. The wrapper 24 may have at least one hole through which external air flows inside or internal gas flows outside. For example, the cigarette 2 may be wrapped with one wrapper 24. As another example, the cigarette 2 may be wrapped with two or more wrappers 24 in an overlapping manner. For example, the tobacco rod 21 may be wrapped with a first wrapper 24a, and the filter rod 22 may be wrapped with wrappers 24b, 24c, and 24d. In addition, the cigarette 2 may be entirely wrapped again with a single wrapper 24e. For example, when the filter rod 22 includes a plurality of segments, the segments may be wrapped with the wrappers 24b, 24c, and 24d, respectively.

The first wrapper 24a and the second wrapper 24b may be formed of general filter wrapping paper. For example, the first wrapper 24a and the second wrapper 24b may be porous wrapping paper or non-porous wrapping paper. In addition, the first wrapper 24a and the second wrapper 24b may be formed of oilproof paper and/or an aluminum laminated wrapping material.

The third wrapper 24c may be formed of hard wrapping paper. For example, a basis weight of the third wrapper 24c may be in a range of 88 grams per square meter (g/m²) to 96 g/m², and desirably, may be in a range of 90 g/m² to 94 g/m². In addition, a thickness of the third wrapper 24c may be in a range of 120 micrometers (μm) to 130 μm, and desirably, may be 125 μm.

The fourth wrapper 24d may be formed of oilproof hard wrapping paper. For example, a basis weight of the fourth wrapper 24d may be in a range of 88 g/m² to 96 g/m², and desirably, may be in a range of 90 g/m² to 94 g/m². In addition, a thickness of the fourth wrapper 21d may be in a range of 120 μm to 130 μm, and desirably, may be 125 μm.

The fifth wrapper 24e may be formed of sterile paper (e.g., MFW). Here, the sterile paper (MFW) may refer to paper specially prepared such that it has enhanced tensile strength, water resistance, smoothness, or the like, compared to general paper. For example, a basis weight of the fifth wrapper 24e may be in a range of 57 g/m² to 63 g/m², and desirably, may be 60 g/m². In addition, a thickness of the fifth wrapper 24e may be in a range of 64 μm to 70 μm, and desirably, may be 67 μm.

The fifth wrapper 24e may have a predetermined material internally added thereto. The predetermined material may be, for example, silicon. However, embodiments are not limited thereto. Silicon may have properties, such as, for example, heat resistance which is characterized by less change by temperature, oxidation resistance which refers to resistance to oxidation, resistance to various chemicals, water repellency against water, or electrical insulation. However, silicon may not be necessarily used, but any material having such properties described above may be applied (or coated) to the fifth wrapper 24e without limitation.

The fifth wrapper 24e may prevent the cigarette 2 from burning. For example, there may be a probability that the cigarette 2 burns when the tobacco rod 21 is heated by the heater 13. For example, when the temperature rises above an ignition point of any one of materials included in the tobacco rod 21, the cigarette 2 may burn. Even in this case, it may still be possible to prevent the cigarette 2 from burning because the fifth wrapper 24e includes a non-combustible material.

In addition, the fifth wrapper 24e may prevent a holder from being contaminated by substances produced in the cigarette 2. For example, liquid substances may be produced in the cigarette 2 when a user puffs. For example, as an aerosol generated in the cigarette 2 is cooled by external air, such liquid substances (e.g., water, etc.) may be produced. Thus, wrapping the cigarette 2 with the fifth wrapper 24e may prevent the liquid substances produced in the cigarette 2 from leaking out of the cigarette 2.

The tobacco rod 21 may include an aerosol generating material. The aerosol generating material may include, for example, at least one of glycerin, propylene glycol, ethylene glycol, dipropylene glycol, diethylene glycol, triethylene glycol, tetraethylene glycol, or oleyl alcohol. However, embodiments are not limited thereto. The tobacco rod 21 may also include other additives, such as, for example, a flavoring agent, a wetting agent, and/or an organic acid. In addition, the tobacco rod 21 may include a flavoring liquid such as menthol or a moisturizing agent that is added as being sprayed onto the tobacco rod 21.

The tobacco rod 21 may be manufactured in various forms. For example, the tobacco rod 21 may be manufactured as a sheet or as a strand. The tobacco rod 21 may also be formed of tobacco leaves finely cut from a tobacco sheet. In addition, the tobacco rod 21 may be enveloped by a thermally conductive material. The thermally conductive material may be, for example, a metal foil such as an aluminum foil, but is not limited thereto. For example, the thermally conductive material enveloping the tobacco rod 21 may evenly distribute the heat transferred to the tobacco rod 21 to improve the thermal conductivity to be applied to the tobacco rod 21, thereby improving the taste of tobacco. In addition, the thermally conductive material enveloping the tobacco rod 21 may function as a susceptor heated by an induction heater. In this case, although not shown, the tobacco rod 21 may further include an additional susceptor in addition to the thermally conductive material enveloping the outside thereof.

The filter rod 22 may be a cellulose acetate filter. However, there is no limit to the shape of the filter rod 22. For example, the filter rod 22 may be a cylindrical rod or a tubular rod including a hollow therein. The filter rod 22 may also be a recess-type rod. For example, when the filter rod 22 includes a plurality of segments, at least one of the segments may be manufactured in a different shape.

A first segment of the filter rod 22 may be a cellulose acetate filter. For example, the first segment may be a tubular structure including a hollow therein. The first segment may prevent internal materials of the tobacco rod 21 from being pushed back when the heater 13 is inserted into the tobacco rod 21 and may cool the aerosol. A desirable diameter of the hollow included in the first segment may be adopted from a range of 2 mm to 4.5 mm, but is not limited thereto.

A desirable length of the first segment may be adopted from a range of 4 mm to 30 mm, but is not limited thereto. Desirably, the length of the first segment may be 10 mm, but is not limited thereto.

The first segment may have a hardness that is adjustable through an adjustment of the content of a plasticizer in a process of manufacturing the first segment. In addition, the first segment may be manufactured by inserting a structure such as a film or a tube of the same or different materials inside (e.g., the hollow).

A second segment of the filter rod 22 may cool an aerosol generated as the heater 13 heats the tobacco rod 21. The user may thus inhale the aerosol cooled down to a suitable temperature.

A length or diameter of the second segment may be determined in various ways according to the shape of the cigarette 2. For example, a length of the second segment may be properly adopted within a range of from 7 mm to 20 mm. Desirably, the length of the second segment may be about 14 mm. However, embodiments are not limited thereto.

The second segment may be manufactured by weaving a polymer fiber. In this case, a flavoring liquid may be applied to a fiber formed of a polymer. Alternatively, the second segment may be manufactured by weaving a separate fiber to which a flavoring liquid is applied and the fiber formed of the polymer together. Alternatively, the second segment may be formed of a crimped polymer sheet.

For example, the polymer may be prepared with a material selected from the group consisting of polyethylene (PE), polypropylene (PP), polyvinyl chloride (PVC), polyethylene terephthalate (PET), polylactic acid (PLA), cellulose acetate (CA) and aluminum foil.

As the second segment is formed of the woven polymer fiber or the crimped polymer sheet, the second segment may include a single channel or a plurality of channels extending in a longitudinal direction. A channel used herein may refer to a path through which a gas (e.g., air or aerosol) passes.

For example, the second segment made of the crimped polymer sheet may be formed of a material having a thickness between about 5 μm and about 300 μm, for example, between about 10 μm and about 250 μm. In addition, a total surface area of the second segment may be between about 300 mm²/mm and about 1000 mm²/mm. Further, an aerosol cooling element may be formed from a material having a specific surface area between about 10 mm²/mg and about 100 mm²/mg.

The second segment may include a thread containing a volatile flavor ingredient. The volatile flavor ingredient may be menthol, but is not limited thereto. For example, the thread may be filled with an amount of menthol sufficient to provide at least 1.5 milligrams (mg) of menthol to the second segment.

A third segment of the filter rod 22 may be a cellulose acetate filter. A length of the third segment may be properly adopted within a range of from 4 mm to 20 mm. For example, the length of the third segment may be about 12 mm, but is not limited thereto.

The third segment may be manufactured such that a flavor is generated by spraying a flavoring liquid onto the third segment in a process of manufacturing the third segment. Alternatively, a separate fiber to which the flavoring liquid is applied may be inserted into the third segment. An aerosol generated in the tobacco rod 21 may be cooled as it passes through the second segment of the filter rod 22, and the cooled aerosol may pass through the third segment into the user. Accordingly, when a flavoring element is added to the third segment, the durability of the flavor to be carried to the user may be enhanced.

In addition, the filter rod 22 may include at least one capsule 23. The capsule 23 may perform a function of generating a flavor, or a function of generating an aerosol. For example, the capsule 23 may be of a structure in which a liquid containing a fragrance is wrapped with a film. The capsule 23 may have a spherical or cylindrical shape. However, embodiments are not limited thereto.

Referring to FIG. 6, a cigarette 3 may further include a front end plug 33. The front end plug 33 may be disposed on one side of a tobacco rod 31 opposite to a filter rod 32. The front end plug 33 may prevent the tobacco rod 31 from escaping to the outside, and may also prevent an aerosol liquefied from the tobacco rod 31 during smoking from flowing into an aerosol generating device (e.g., the electronic device 1 of FIGS. 2 to 4).

The filter rod 32 may include a first segment 32a and a second segment 32b. The first segment 32a may correspond to the first segment of the filter rod 22 of FIG. 5, and the second segment 32b may correspond to the third segment of the filter rod 22 of FIG. 5.

A diameter and a total length of the cigarette 3 may correspond to the diameter and the total length of the cigarette 2 of FIG. 5. For example, a length of the front end plug 33 may be about 7 mm, a length of the tobacco rod 31 may be about 15 mm, a length of the first segment 32a may be about 12 mm, and a length of the second segment 32b may be about 14 mm. However, embodiments are not limited thereto.

The cigarette 3 may be wrapped with at least one wrapper 35. The wrapper 35 may have at least one hole through which external air flows inside or internal gas flows outside. For example, the front end plug 33 may be wrapped with a first wrapper 35a, the tobacco rod 31 may be wrapped with a second wrapper 35b, the first segment 32a may be wrapped with a third wrapper 35c, and the second segment 32b may be wrapped with a fourth wrapper 35d. In addition, the cigarette 3 may be entirely wrapped again with a fifth wrapper 35e.

In addition, at least one perforation 36 may be formed on the fifth wrapper 35e. For example, the perforation 36 may be formed in an area surrounding the tobacco rod 31. However, embodiments are not limited thereto. The perforation 36 may perform a function of transferring heat generated by the heater 13 shown in FIGS. 3 and 4 to the inside of the tobacco rod 31.

In addition, the second segment 32b may include at least one capsule 34. The capsule 34 may perform a function of generating a flavor or a function of generating an aerosol. For example, the capsule 34 may have a structure in which a liquid containing a fragrance is wrapped with a film. The capsule 34 may have a spherical or cylindrical shape, but is not limited thereto.

The first wrapper 35a may be a combination of general filter wrapping paper and a metal foil such as an aluminum foil. For example, a total thickness of the first wrapper 35a may be in a range of 45 μm to 55 μm, and desirably, may be 50.3 μm. In addition, a thickness of the metal foil of the first wrapper 35a may be in a range of 6 μm to 7 μm, and desirably, may be 6.3 μm. In addition, a basis weight of the first wrapper 35a may be in a range of 50 g/m² to 55 g/m², and desirably, may be 53 g/m².

The second wrapper 35b and the third wrapper 35c may be formed of general filter wrapping paper. For example, the second wrapper 35b and the third wrapper 35c may be porous wrapping paper or non-porous wrapping paper.

For example, the porosity of the second wrapper 35b may be 35000 CU, but is not limited thereto. In addition, a thickness of the second wrapper 35b may be in a range of 70 μm to 80 μm, and desirably, may be 78 μm. In addition, a basis weight of the second wrapper 35b may be in a range of 20 g/m² to 25 g/m², and may desirably, be 23.5 g/m².

For example, the porosity of the third wrapper 35c may be 24000 CU, but is not limited thereto. In addition, a thickness of the third wrapper 35c may be in a range of 60 μm to 70 μm, and desirably, may be 68 μm. In addition, a basis weight of the third wrapper 35c may be in a range of 20 g/m² to 25 g/m², and desirably, may be 21 g/m².

The fourth wrapper 35d may be formed with polylactic acid (PLA) laminated paper. The PLA laminated paper may refer to three-ply paper including a paper layer, a PLA layer, and another paper layer. For example, a thickness of the fourth wrapper 35d may be in a range of 100 μm to 120 μm, and desirably, may be 110 μm. In addition, a basis weight of the fourth wrapper 35d may be in a range of 80 g/m² to 100 g/m², and desirably, may be 88 g/m².

The fifth wrapper 35e may be formed of sterile paper (e.g., MFW). Here, the sterile paper (MFW) may refer to paper specially prepared such that it has enhanced tensile strength, water resistance, smoothness, or the like, compared to general paper. For example, a basis weight of the fifth wrapper 35e may be in a range of 57 g/m² to 63 g/m², and desirably, may be 60 g/m². In addition, a thickness of the fifth wrapper 35e may be in a range of 64 μm to 70 μm, and desirably, may be 67 μm.

The fifth wrapper 35e may have a predetermined material internally added thereto. The predetermined material may be, for example, silicon. However, embodiments are not limited thereto. Silicon may have properties, such as, for example, heat resistance which is characterized by less change by temperature, oxidation resistance which refers to resistance to oxidation, resistance to various chemicals, water repellency against water, or electrical insulation. However, silicon may not be necessarily used, but any material having such properties described above may be applied (or coated) to the fifth wrapper 35e without limitation.

The front end plug 33 may be formed of cellulose acetate. For example, the front end plug 33 may be manufactured by adding a plasticizer (e.g., triacetin) to cellulose acetate tow. A mono denier of a filament constituting the cellulose acetate tow may be in a range of 1.0 to 10.0, and desirably, may be in a range of 4.0 to 6.0. The mono denier of the filament of the front end plug 33 may be more desirably 5.0. In addition, a cross-section of the filament constituting the front end plug 33 may be Y-shaped. A total denier of the front end plug 33 may be in a range of 20000 to 30000, and desirably, may be in a range of 25000 to 30000. The total denier of the front end plug 33 may be more desirably 28000.

In addition, as needed, the front end plug 33 may include at least one channel, and a cross-sectional shape of the channel may be provided in various ways.

The tobacco rod 31 may correspond to the tobacco rod 21 described above with reference to FIG. 5. Thus, a detailed description of the tobacco rod 31 will be omitted here.

The first segment 32a may be formed of cellulose acetate. For example, the first segment may be a tubular structure including a hollow therein. The first segment 32a may be manufactured by adding a plasticizer (e.g., triacetin) to cellulose acetate tow. For example, a mono denier and a total denier of the first segment 32a may be the same as the mono denier and the total denier of the front end plug 33.

The second segment 32b may be formed of cellulose acetate. A mono denier of a filament constituting the second segment 32b may be in a range of 1.0 to 10.0, and desirably, may be in a range of 8.0 to 10.0. The mono denier of the filament of the second segment 32b may be more desirably 9.0. In addition, a cross-section of the filament of the second segment 32b may be Y-shaped. A total denier of the second segment 32b may be in a range of 20000 to 30000, and desirably, may be 25000.

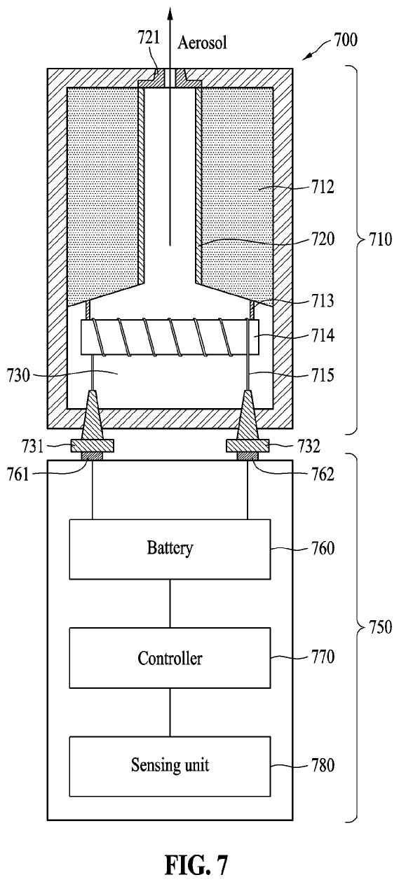

FIG. 7 is a simplified view of an electronic device according to another example.

According to an embodiment, an electronic device 700 may include a cartridge 710 and a body 750. The cartridge 710 electrically connected to the body 750 may be of a replaceable type. In FIG. 7, a structure of a connecting portion (e.g., a slider) capable of mechanically connecting the body 750 and the cartridge 710 or bringing them into close contact with each other is omitted. For example, the connecting portion may be movably coupled to the body 750, and the connecting portion may perform a function of covering at least a portion of a mouthpiece (e.g., a mouthpiece 721) of the cartridge 710 coupled to the body 750 or externally exposing at least the portion of the mouthpiece, as the connecting portion moves with respect to the body 750.

According to an embodiment, the cartridge 710 may include a storage 712, a material transfer hole 713, a wick 714, a heating element (or a heater) 715, electrodes 731 and 732, a transfer tube 720, and the mouthpiece 721.

The storage 712 may include a liquid aerosol generating material.

The material transfer hole 713 may transfer at least a portion of the aerosol generating material in the storage 712 to the heating element 715.

The wick 714 may absorb and retain the aerosol generating material supplied through the material transfer hole 713. For example, the wick 714 may include at least one of cotton fiber, ceramic fiber, glass fiber, or porous ceramic.

The heating element 715 may wind the wick 714 multiple times. The heating element 715 may be a resistive coil. The heating element 715 may be connected to the electrodes 731 and 732 and may receive power (or a current) through the electrodes 731 and 732. When the heating element 715 generates heat and heats the wick 714, the aerosol generating material supplied to the wick 714 may be atomized to generate an aerosol in a chamber 730, and the user may absorb the aerosol through the transfer tube 720 and the mouthpiece 721.

According to an embodiment, the body 750 may include a battery 760, a controller 770, and a sensing unit 780.

The battery 760 may supply power to the heating element 715 through electrodes 761 and 762.

The controller 770 may control the overall operation of the electronic device 700.

The description of the sensing unit 780 may be replaced with the description of the sensing unit 10 provided above with reference to FIGS. 2 to 4.

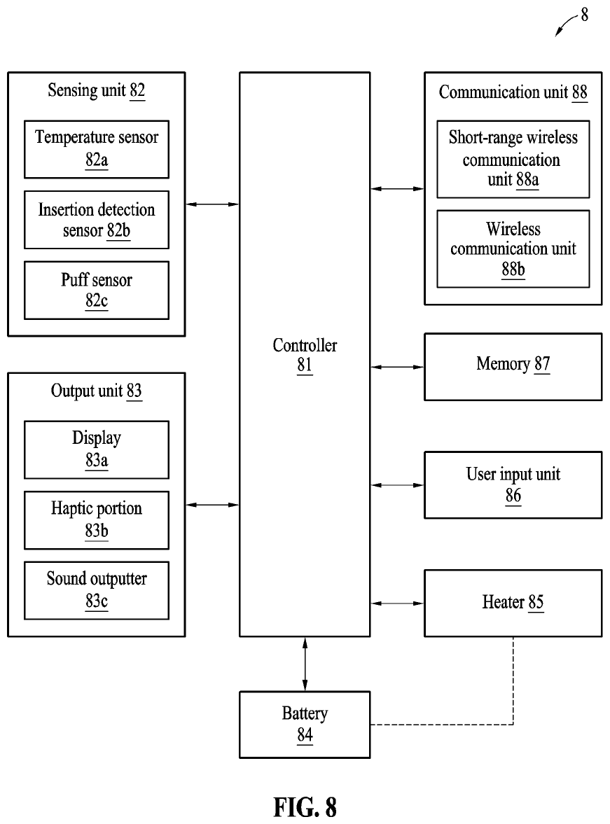

FIG. 8 is a block diagram of an electronic device according to yet another example.

According to an embodiment, an electronic device 8 may include a controller 81, a sensing unit 82, an output unit 83, a battery 84, a heater 85, a user input unit 86, a memory 87, and a communication unit 88. However, an internal structure of the electronic device 8 is not limited to what is shown in FIG. 8. It is to be understood by one of ordinary skill in the art to which the disclosure pertains that some of the components shown in FIG. 8 may be omitted or new components may be added according to the design of the electronic device 8.

The sensing unit 82 may sense a state of the electronic device 8 or a state around the electronic device 8, and may provide sensing information to the controller 81. Based on the sensing information, the controller 81 may control the electronic device 8 to control operations of the heater 85, restrict smoking, determine whether an aerosol generating article (e.g., a cigarette, a cartridge, etc.) is inserted, display a notification, and perform other functions.

The sensing unit 82 may include at least one of a temperature sensor 82a, an insertion detection sensor 82b, or a puff sensor 82c, but is not limited thereto. For example, the sensing unit 82 may include the sensors of the sensing unit 10 or the sensing unit 780 described above with reference to FIGS. 2 to 7.

The temperature sensor 82a may sense a temperature at which the heater 85 (or an aerosol generating material) is heated. The electronic device 8 may include a separate temperature sensor for sensing the temperature of the heater 85, or the heater 85 itself may perform a function as a temperature sensor. Alternatively, the temperature sensor 82a may be arranged around the battery 84 to monitor a temperature of the battery 84.

The insertion detection sensor 82b may sense whether the aerosol generating article is inserted or removed. The insertion detection sensor 82b may include, for example, at least one of a film sensor, a pressure sensor, a light sensor, a resistive sensor, a capacitive sensor, an inductive sensor, or an infrared sensor, which may sense a signal change by the insertion or removal of the aerosol generating article.

The puff sensor 82c may sense a puff from a user based on various physical changes in an airflow path or airflow channel. For example, the puff sensor 82c may sense the puff from the user based on any one of a temperature change, a flow change, a voltage change, and a pressure change.

The sensing unit 82 may further include at least one of a temperature/humidity sensor, an atmospheric pressure sensor, a magnetic sensor, an acceleration sensor, a gyroscope sensor, a position sensor (e.g., a global positioning system (GPS)), a proximity sensor, and a red, green, blue (RGB) sensor (e.g., an illuminance sensor), in addition to the sensors 82a to 82c described above. A function of each sensor may be intuitively inferable from its name by one of ordinary skill in the art, and thus, a more detailed description thereof will be omitted here.

The output unit 83 may output information on a state of the electronic device 8 and provide the information to the user. The output unit 83 may include at least one of a display 83a, a haptic portion 83b, or a sound outputter 83c, but is not limited thereto. When the display 83a and a touchpad are provided in a layered structure to form a touchscreen, the display 83a may be used as an input device in addition to an output device.

The display 83a may visually provide the information about the electronic device 8 to the user. The information about the electronic device 8 may include, for example, a charging/discharging state of the battery 84 of the electronic device 8, a preheating state of the heater 85, an insertion/removal state of the aerosol generating article, a limited usage state (e.g., an abnormal item detected) of the electronic device 8, or the like, and the display 83a may externally output the information. The display 83a may be, for example, a liquid-crystal display panel (LCD), an organic light-emitting display panel (OLED), or the like. The display 83a may also be in the form of a light-emitting diode (LED) device.

The haptic portion 83b may provide the information on the electronic device 8 to the user in a haptic way by converting an electrical signal into a mechanical stimulus or an electrical stimulus. The haptic portion 83b may include, for example, a motor, a piezoelectric element, or an electrical stimulation device.

The sound outputter 83c may provide the information about the electronic device 8 to the user in an auditory way. For example, the sound outputter 83c may convert an electrical signal into a sound signal and externally output the sound signal.

The battery 84 may supply power to be used to operate the electronic device 8. The battery 84 may supply power to heat the heater 85. In addition, the battery 84 may supply power required for operations of the other components (e.g., the sensing unit 82, the output unit 83, the user input unit 86, the memory 87, and the communication unit 88) included in the electronic device 8. The battery 84 may be a rechargeable battery or a disposable battery. The battery 84 may be, for example, a lithium polymer (LiPoly) battery. However, embodiments are not limited thereto.

The heater 85 may receive power from the battery 84 to heat the aerosol generating material. Although not shown in FIG. 8, the electronic device 8 may further include a power conversion circuit (e.g., a direct current (DC)-to-DC (DC/DC) converter) that converts power of the battery 84 and supplies the power to the heater 85. In addition, when the electronic device 8 generates an aerosol in an induction heating manner, the electronic device 8 may further include a DC-to-alternating current (AC) (DC/AC) converter that converts DC power of the battery 84 into AC power.

The controller 81, the sensing unit 82, the output unit 83, the user input unit 86, the memory 87, and the communication unit 88 may receive power from the battery 84 to perform functions. Although not shown in FIG. 8, a power conversion circuit, for example, a low dropout (LDO) circuit or a voltage regulator circuit, which converts power of the battery 84 and supplies the power to respective components, may further be included.

In an embodiment, the heater 85 may be formed of any suitable electrically resistive material. The electrically resistive material may be a metal or a metal alloy including, for example, titanium, zirconium, tantalum, platinum, nickel, cobalt, chromium, hafnium, niobium, molybdenum, tungsten, tin, gallium, manganese, iron, copper, stainless steel, nichrome, or the like. However, embodiments are not limited thereto. In addition, the heater 85 may be implemented as a metal heating wire, a metal heating plate on which an electrically conductive track is arranged, a ceramic heating structure, or the like, but is not limited thereto.

In another embodiment, the heater 85 may be an induction heater. For example, the heater 85 may include a susceptor that heats the aerosol generating material by generating heat through a magnetic field applied by a coil.

In an embodiment, the heater 85 may include a plurality of heaters. For example, the heater 85 may include a first heater for heating a cigarette and a second heater for heating a liquid.

The user input unit 86 may receive information input from the user or may output information to the user. For example, the user input unit 86 may include a key pad, a dome switch, a touchpad (e.g., a contact capacitive type, a pressure resistive film type, an infrared sensing type, a surface ultrasonic conduction type, an integral tension measurement type, a piezo effect method, etc.), a jog wheel, a jog switch, or the like, but is not limited thereto. In addition, although not shown in FIG. 8, the electronic device 8 may further include a connection interface such as a universal serial bus (USB) interface, and may be connected to another external device through the connection interface such as a USB interface to transmit and receive information or to charge the battery 84.

The memory 87, which is hardware for storing various pieces of data processed in the electronic device 8, may store data processed by the controller 81 and data to be processed by the controller 81. The memory 87 may include at least one type of storage medium of a flash memory type memory, a hard disk type memory, a multimedia card micro type memory, a card type memory (e.g., an SD or XD memory), a random access memory (RAM), a static random access memory (SRAM), a read-only memory (ROM), an electrically erasable programmable read-only memory (EEPROM), a programmable read-only memory (PROM), a magnetic memory, a magnetic disk, or an optical disk. The memory 87 may store an operating time of the electronic device 8, a maximum number of puffs, a current number of puffs, at least one temperature profile, data associated with a smoking pattern of the user, or the like.

The communication unit 88 may include at least one component for communicating with another electronic device. For example, the communication unit 88 may include a short-range wireless communication unit 88a and a wireless communication unit 88b.

The short-range wireless communication unit 88a may include a Bluetooth communication unit, a Bluetooth low energy (BLE) communication unit, a near field communication unit, a wireless local area network WLAN (wireless fidelity (Wi-Fi)) communication unit, a ZigBee communication unit, an infrared data association (IrDA) communication unit, a Wi-Fi direct (WFD) communication unit, an ultra-wideband (UWB) communication unit, and an Ant+ communication unit. However, embodiments are not limited thereto.

The wireless communication unit 88b may include, for example, a cellular network communication unit, an Internet communication unit, a computer network (e.g., a LAN or a wide-area network (WAN)) communication unit, or the like. However, embodiments are not limited thereto. The wireless communication unit 88b may use subscriber information (e.g., international mobile subscriber identity (IMSI)) to identify and authenticate the electronic device 8 in a communication network.

The controller 81 may control the overall operation of the electronic device 8. In an embodiment, the controller 81 may include at least one processor. The processor may be implemented as an array of a plurality of logic gates, or may be implemented as a combination of a general-purpose microprocessor and a memory in which a program executable in the microprocessor is stored. In addition, it is to be understood by one of ordinary skill in the art to which the disclosure pertains that it may be implemented in other types of hardware.

The controller 81 may control the temperature of the heater 85 by controlling the supply of power from the battery 84 to the heater 85. For example, the controller 81 may control the supply of power by controlling the switching of a switching element between the battery 84 and the heater 85. As another example, a direct heating circuit may control the supply of power to the heater 85 according to a control command from the controller 81.

The controller 81 may analyze a sensing result obtained by the sensing of the sensing unit 82 and control processes to be performed thereafter. For example, the controller 81 may control power to be supplied to the heater 85 to start or end an operation of the heater 85 based on the sensing result obtained by the sensing unit 82. As another example, the controller 81 may control an amount of power to be supplied to the heater 85 and a time for which the power is to be supplied such that the heater 85 may be heated up to a predetermined temperature or maintained at a desired temperature, based on the sensing result obtained by the sensing unit 82.

The controller 81 may control the output unit 83 based on the sensing result obtained by the sensing unit 82. For example, when the number of puffs counted through the puff sensor 82c reaches a preset number, the controller 81 may inform the user that the electronic device 8 is ending soon, through at least one of the display 83a, the haptic portion 83b, or the sound outputter 83c.

In an embodiment, the controller 81 may control a power supply time and/or a power supply amount for the heater 85 according to a state of the aerosol generating article sensed by the sensing unit 82. For example, when an aerosol generating substrate is in an over-humidified state, the controller 81 may control the power supply time for an inductive coil to increase a preheating time, compared to a case where the aerosol generating substrate is in a general state.

FIG. 9 is a diagram illustrating a configuration of a user terminal according to an embodiment.

A user terminal 900 includes a communication unit 910, a processor 920, and a memory 930. For example, the user terminal 900 may be the user terminal 110 described above with reference to FIG. 1.

The communication unit 910 may be connected to the processor 920 and the memory 930 and transmit and receive data to and from the processor 920 and the memory 930. The communication unit 910 may be connected to another external device and transmit and receive data to and from the external device. Hereinafter, transmitting and receiving “A” may refer to transmitting and receiving “information or data indicating A”.

The communication unit 910 may be implemented as circuitry in the user terminal 900. For example, the communication unit 910 may include an internal bus and an external bus. As another example, the communication unit 910 may be an element configured to connect the user terminal 900 to an external device. The communication unit 910 may be an interface. The communication unit 910 may receive data from the external device and transmit the data to the processor 920 and the memory 930.

The processor 920 may process the data received by the communication unit 910 and data stored in the memory 930. A “processor” may be a hardware-implemented data processing device having a physically structured circuit to execute desired operations. The desired operations may include, for example, codes or instructions included in a program. The hardware-implemented data processing device may include, for example, a microprocessor, a central processing unit (CPU), a processor core, a multi-core processor, a multiprocessor, an application-specific integrated circuit (ASIC), and a field-programmable gate array (FPGA).

The processor 920 may execute computer-readable code (e.g., software) stored in a memory (e.g., the memory 930) and instructions triggered by the processor 920.

The memory 930 may store therein the data received by the communication unit 910 and the data processed by the processor 920. For example, the memory 930 may store the program (or an application or software). The program to be stored may be a set of syntaxes that are coded and executable by the processor 920 to control an additional device (e.g., the electronic device 120 or the wearable device 130 of FIG. 1).

According to an aspect, the memory 930 may include, for example, at least one volatile memory, nonvolatile memory, RAM, flash memory, a hard disk drive, and an optical disc drive.

The memory 930 may store an instruction set (e.g., software) for operating the user terminal 900. The instruction set for operating the user terminal 900 may be executed by the processor 920.

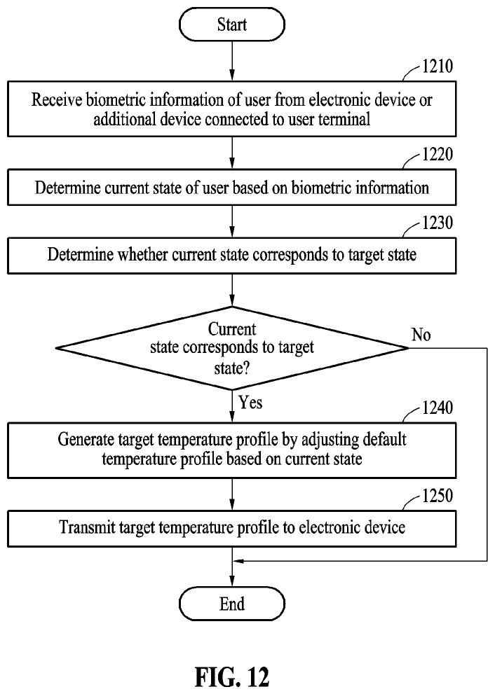

The communication unit 910, the processor 920, and the memory 930 will be described below in detail with reference to FIG. 12.

FIG. 10 is a flowchart of a method of generating an aerosol performed by an electronic device according to an embodiment.

Operations 1010 to 1060 may be performed by an electronic device (e.g., the electronic device 120 of FIG. 1, the electronic device 1 of FIGS. 2 to 4, and the electronic device 700 of FIG. 7). For example, the electronic device may be an electronic cigarette device.

In operation 1010, the electronic device may receive biometric information of a user of the electronic device. For example, the biometric information may be at least one of a heart rate, a skin temperature, a skin dryness level, and a perspiration level of the user. For example, the perspiration level may indicate a degree of sweat generated from a fingertip of the user.

According to an embodiment, the electronic device may measure the biometric information of the user using a sensor in a sensing unit (e.g., the sensing unit 10).

According to another embodiment, the electronic device may receive, from an additional device (e.g., the wearable device 130 of FIG. 1) connected to the electronic device, the biometric information of the user measured by the additional device.

Additionally, the electronic device may generate at least one of inhalation information and exhalation information of the user using the sensing unit in the electronic device. For example, the electronic device may extract health data related to a heart rate, lung capacity, or intake of air of the user through the biometric information, the inhalation information, and the exhalation information and predict a current health state according to physical factors or mental factors (e.g., stress) of the user based on the health data.

Accordingly, the electronic device may provide a short-term service for relieving stress of the user and a long-term service related to health care to the user. For example, when a state of the user is predicted to be in a high stress state (or a tension state) through the biometric information, the inhalation information, and the exhalation information, deep inhalation by the user may be induced to relieve the high stress state of the user. Operations for inducing the deep inhalation by the user are described below.

In operation 1020, the electronic device may determine a current state of the user based on the biometric information. For example, the electronic device may determine the current state of the user among a plurality of states based on biometric information measured at a current time.

According to an embodiment, the plurality of states may be preset to correspond to a level of stress of the user. For example, the plurality of states may include a normal state, a low stress state, and a high stress state. For example, it may be determined that the level of stress is high when temperatures of extremities (e.g., a finger) of the user is low, a perspiration level is high, and a puff interval is short.

According to an embodiment, the plurality of states may be preset based on demographic statistics related to a variety of element information to be measured. According to an example, the user may self-diagnose his/her own state and preset the plurality of states based on currently measured biometric information. For example, the user may self-diagnose his/her own current state as a normal state and measure biometric information exhibited in the normal state using the electronic device. The electronic device may personalize an individual state by setting the measured biometric information as a reference value of the normal state.

In operation 1030, the electronic device may determine whether the current state corresponds to a target state. For example, the electronic device may determine whether the current state corresponds to the high stress state.

Operation 1050 may be performed when the current state corresponds to the target state, and operation 1040 may be performed when the current state does not correspond to the target state.

In operation 1040, when the current state does not correspond to the target state, the electronic device may generate an aerosol by heating an aerosol generating substrate in the electronic device based on a default temperature profile. For example, the default temperature profile may be a temperature profile for providing an aerosol to the user in its general use form. A temperature of a heater (e.g., the heater 13 of FIG. 2 or the vaporizer 14 of FIG. 4) of the electronic device may be controlled based on the temperature profile.

In operation 1050, when the current state corresponds to the target state, the electronic device may generate a target temperature profile by adjusting the default temperature profile based on the current state. As a stress level increases, a variation in the default temperature profile may increase. For example, the target temperature profile may be generated such that an amount of atomization decreases, the amount of atomization being generated by the aerosol generating substrate when the user absorbs mainstream smoke. The user may deeply inhale to recover the reduced amount of atomization. A level of tension or stress of the user may be lowered by the deep inhalation.

The above-described embodiment describes that a target temperature profile is generated by adjusting one default temperature profile. However, according to another embodiment, a target default temperature profile corresponding to the target state among a plurality of default temperature profiles stored in advance to be associated with the plurality of states may be determined.

According to an aspect, one default temperature profile or the plurality of default temperature profiles may be a temperature profile that is personalized in advance by the user. For example, the user may personalize a temperature profile through a user terminal (e.g., an application of a user terminal) connected to the electronic device.

According to an embodiment, the electronic device may generate the target temperature profile such that a second amount of aerosol generated by the target temperature profile is reduced compared to a first amount of aerosol generated by the default temperature profile.

In operation 1060, the electronic device may generate the aerosol by heating the aerosol generating substrate in the electronic device based on the target temperature profile. The second amount of aerosol generated based on the target temperature profile may be reduced compared to the first amount of aerosol generated based on the default temperature profile. The user may deeply inhale to recover the reduced amount of aerosol (e.g., the amount of atomization). The level of tension or stress of the user may be lowered by the deep inhalation.

Operations 1010 to 1060 may be performed repeatedly.

In operation 1010, which is performed again, the electronic device may receive second biometric information of the user.

In operation 1020, which is performed again, the electronic device may determine a second current state of the user based on the second biometric information.

In operation 1030, which is performed again, the electronic device may determine whether the second current state corresponds to a preset target state. The target state may be a stress state that is the same as or higher than the target state set in previous operation 1030.

In operation 1050, which is performed again, when the second current state corresponds to the target state, the electronic device may generate a second target temperature profile by adjusting the target temperature profile based on the second current state. A third amount of aerosol generated based on the second target temperature profile may be further reduced compared to the second amount of aerosol generated based on the target temperature profile. The user may inhale more deeply to recover the reduced amount of aerosol (e.g., the amount of atomization). The level of tension or stress of the user may be lowered by the deep inhalation.

In operation 1040, which is performed again, the electronic device may generate the aerosol by heating the aerosol generating substrate in the electronic device based on a default temperature profile.

As operations 1010 to 1060 are performed repeatedly, the default temperature profile may be used to heat the aerosol generating substrate when it is determined that the current state of the user is the normal state.

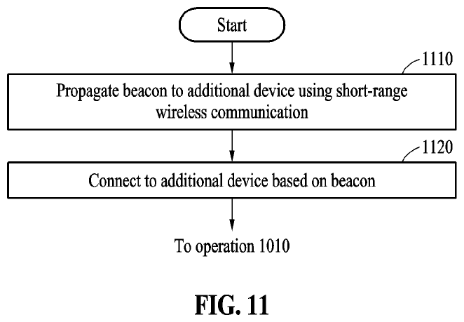

FIG. 11 is a flowchart of a method of establishing a connection between an electronic device and an additional device according to an example.

According to an embodiment, operations 1110 and 1120 may be further performed before operation 1010 described above with reference to FIG. 10 is performed.

In operation 1110, an electronic device may propagate (or transmit) a beacon to an additional device (e.g., the wearable device 130 of FIG. 1) using short-range wireless communication. For example, the short-range wireless communication may be one of Bluetooth, Bluetooth low energy (BLE), near field communication (NFC), and wireless fidelity (Wi-Fi), and is not limited to the described embodiments.

In operation 1120, the electronic device may be connected to the additional device based on the beacon. For example, a channel may be formed between the electronic device and the additional device, and biometric information of a user generated by the additional device may be transmitted to the electronic device through the channel.

The embodiment in which the electronic device propagates the beacon and the additional device receives the beacon is described through operations 1110 and 1120, but an embodiment in which the additional device propagates the beacon and the electronic device receives the beacon may be possible.

The embodiment in which the aerosol is provided to the user based on the target temperature profile generated by the electronic device is described with reference to FIGS. 10 and 11, and the embodiment in which the aerosol is provided to the user based on the target temperature profile generated by a user terminal is described with reference to FIG. 12.

FIG. 12 is a flowchart of a method of providing an aerosol to a user based on a temperature profile generated by a user terminal according to an embodiment.

Operations 1210 to 1250 may be performed by a user terminal (e.g., the user terminal 110 of FIG. 1). For example, operations 1210 to 1250 may be performed by a program or an application installed in the user terminal.

In operation 1210, the user terminal may receive biometric information of a user from an electronic device or an additional device connected to the user terminal.

According to an embodiment, a sensing unit (e.g., the sensing unit 10) of the electronic device (e.g., the electronic device 120 of FIG. 1, the electronic device 1 of FIGS. 2 to 4, and the electronic device 700 of FIG. 7) may measure the biometric information of the user and transmit the biometric information to the user terminal. Additionally, the electronic device may further measure inhalation information and exhalation information and transmit the inhalation information and the exhalation information to the user terminal.

According to an embodiment, a sensing unit of the additional device (e.g., the wearable device 130 of FIG. 1) may measure the biometric information of the user and transmit the biometric information to the user terminal.

In operation 1220, the user terminal may determine a current state of the user based on the biometric information. For example, the user terminal may determine the current state of the user based on at least one of the biometric information, the inhalation information, and the exhalation information. The description of operation 1020 described above with reference to FIG. 10 may be similarly applied to a method of determining the current state of the user.

In operation 1230, the user terminal may determine whether the current state corresponds to a target state. For example, the user terminal may determine whether the current state corresponds to a high stress state.

Operation 1240 may be performed when the current state corresponds to the target state, and no additional operation may be performed when the current state does not correspond to the target state. The electronic device may heat an aerosol generating substrate using a default temperature profile when there is no particular demand (or instruction) from the user terminal, and an aerosol may be provided to the user by the heated aerosol generating substrate.

In operation 1240, the user terminal may generate a target temperature profile by adjusting the default temperature profile based on the current state. The description of operation 1050 described above with reference to FIG. 10 may be similarly applied to a method of generating the target temperature profile.

In operation 1250, the user terminal may transmit the target temperature profile to the electronic device. For example, the user terminal may transmit the target temperature profile to the electronic device through a short-range wireless communication channel with the electronic device.

According to an embodiment, the electronic device may generate the aerosol by heating the aerosol generating substrate in the electronic device based on the target temperature profile received from the user terminal. The second amount of aerosol generated based on the target temperature profile may be reduced compared to the first amount of aerosol generated based on the default temperature profile. The user may deeply inhale to recover the reduced amount of aerosol (e.g., the amount of atomization). The level of tension or stress of the user may be lowered by the deep inhalation.

The methods according to the embodiments may be recorded in non-transitory computer-readable media including program instructions to implement various operations of the embodiments. The media may also include, alone or in combination with the program instructions, data files, data structures, and the like. The program instructions recorded on the media may be those specially designed and constructed for the purposes of embodiments, or they may be of the kind well-known and available to one of ordinary skill in the computer software arts. Examples of non-transitory computer-readable media include magnetic media such as hard disks, floppy disks, and magnetic tape; optical media such as CD-ROM disks or DVDs; magneto-optical media such as floptical disks; and hardware devices that are specially configured to store and perform program instructions, such as ROM, RAM, flash memory, and the like. Examples of program instructions include both machine code, such as produced by a compiler, and files containing higher-level code that may be executed by the computer using an interpreter. The above-described hardware devices may be configured to act as one or more software modules in order to perform the operations of the embodiments, or vice versa.

The software may include a computer program, a piece of code, an instruction, or one or more combinations thereof, to independently or collectively instruct or configure the processing device to operate as desired. Software and/or data may be embodied permanently or temporarily in any type of machine, component, physical or virtual equipment, computer storage medium or device, or in a propagated signal wave capable of providing instructions or data to or being interpreted by the processing device. The software may also be distributed over network-coupled computer systems so that the software may be stored and executed in a distributed fashion. The software and data may be stored by one or more non-transitory computer-readable recording mediums.

As described above, although the embodiments have been described with reference to the limited drawings, one of ordinary skill in the art may apply various technical modifications and variations based thereon. For example, suitable results may be achieved if the described techniques are performed in a different order and/or if components in a described system, architecture, device, or circuit are combined in a different manner or replaced or supplemented by other components or their equivalents.

Therefore, other implementations, other embodiments, and equivalents to the claims are also within the scope of the following claims.

1. A method of generating an aerosol, performed by an electronic device, the method comprising:
receiving biometric information of a user of the electronic device;
determining a current state of the user based on the biometric information;
when the current state corresponds to a preset target state, generating a target temperature profile by adjusting a default temperature profile based on the current state; and
generating an aerosol by heating an aerosol generating substrate in the electronic device based on the target temperature profile.

2. The method of claim 1, wherein the receiving of the biometric information of the user comprises generating the biometric information using at least one sensor of the electronic device.

3. The method of claim 1, wherein the receiving of the biometric information of the user comprises receiving, from an additional device connected to the electronic device, the biometric information generated based on one or more sensors in the additional device.

4. The method of claim 3, further comprising:
propagating a beacon to the additional device using short-range wireless communication; and
connecting to the additional device based on the beacon.

5. The method of claim 1, wherein the biometric information comprises at least one of a heart rate, a skin temperature, a skin dryness level, and a perspiration level of the user.

6. The method of claim 5, wherein the perspiration level indicates a degree of sweat generated from a fingertip of the user.

7. The method of claim 1, wherein the generating of the target temperature profile by adjusting the default temperature profile based on the current state comprises generating the target temperature profile such that a second amount of aerosol generated by the target temperature profile is reduced compared to a first amount of aerosol generated by the default temperature profile.

8. The method of claim 7, further comprising:
receiving second biometric information of the user;
determining a second current state of the user based on the second biometric information;
when the second current state corresponds to the target state, generating a second target temperature profile by adjusting the target temperature profile based on the second current state; and
generating an aerosol by heating an aerosol generating substrate in the electronic device based on the second target temperature profile.

9. The method of claim 1, wherein the electronic device is an electronic cigarette device.

10. A non-transitory computer-readable storage medium storing instructions that, when executed by a processor, cause the processor to perform the method of claim 1.

11. An electronic device comprising:
a memory configured to store a program for generating an aerosol; and
a processor configured to perform the program
wherein the processor is configured to:
receive biometric information of a user of the electronic device;
determine a current state of the user based on the biometric information;
when the current state corresponds to a preset target state, generate a target temperature profile by adjusting a default temperature profile based on the current state; and
generate an aerosol by heating an aerosol generating substrate in the electronic device based on the target temperature profile.

12. A method of providing an aerosol, performed by a user terminal, the method comprising:
receiving, from an electronic device or an additional device connected to the user terminal, biometric information of a user of the user terminal;
determining a current state of the user based on the biometric information;
when the current state corresponds to a preset target state, generating a target temperature profile by adjusting a default temperature profile based on the current state; and
transmitting the target temperature profile to the electronic device,
wherein an aerosol is provided to the user by the electronic device using the target temperature profile.

13. The method of claim 12, wherein the receiving of the biometric information of the user comprises receiving, from the additional device connected to the user terminal, receiving the biometric information generated based on one or more sensors in the additional device.

14. The method of claim 12, wherein the biometric information comprises at least one of a heart rate, a skin temperature, a skin dryness level, and a perspiration level of the user.

15. The method of claim 12, wherein the generating of the target temperature profile by adjusting the default temperature profile based on the current state comprises generating the target temperature profile such that a second amount of aerosol generated by the target temperature profile is reduced compared to a first amount of aerosol generated by the default temperature profile.
